(19) United States
(12) Patent Application Publication
(10) Pub. No.: US 2026/0330323 A1
(43) Pub. Date: Oct. 22, 2026

(54) HARDWARE AWARE GRADIENT PRIMITIVES FOR MEMORY EFFICIENT MACHINE LEARNING TRAINING

(71) Applicant: Bytedance Technology Ltd., Grand Cayman (KY)

(72) Inventors: Shikun ZHANG, Culver City, CA (US); Jian DU, Culver City, CA (US)

(21) Appl. No.: 19/720,645

(22) Filed: Jun. 25, 2026

(51) Int. Cl. G06N 20/00

(52) U.S. Cl. CPC G06N 20/00

(57) ABSTRACT

The present disclosure involves methods, apparatus, and systems for computing gradient norms. In a first aspect, this includes: receiving, at a processing system for training machine learning models, an input activation matrix of dimensions T and d, where T is the input sequence length and d is a model width partitioning the input activation matrix into a plurality of tiles along the T dimension; storing the partitioned activation matrix in a global memory; and determining, by a compute unit of the processing system, a partial gram matrix by: a. loading a particular tile of the partitioned activation matrix to an on-chip memory; b. calculating a partial gram matrix from the particular tile using a tensor memory accelerator, bypassing register operations; c. accumulating the partial gram matrix directly to a register of the compute unit; d. loading a next tile of the partitioned activation matrix and repeating a. through c.

### TECHNICAL FIELD

The present disclosure generally relates calculating gradient norms for performing machine learning training using techniques to reduce required system memory, communications bandwidth, or both depending on available hardware and model being trained.

### BACKGROUND

Differential privacy (DP) is a framework for releasing statistical information about datasets while protecting the privacy of individual data subjects. DP enables a data holder to share aggregate patterns of a group while limiting information that is leaked about specific individuals. This can be done by injecting noise into statistical computations, such that the utility of the statistic is preserved while provably limiting what can be inferred about any individual in the dataset. When performing model training, to prevent the model from “learning” private information, differentially private training techniques can be employed, such as differentially private stochastic gradient descent (DP-SGD).

### SUMMARY

The present disclosure relates to a method, system, and computer-readable storage media for computing gradient norms. In a first aspect, this includes: receiving, at a processing system for training machine learning models, an input activation matrix of dimensions T and d, where T is the input sequence length and d is a model width partitioning the input activation matrix into a plurality of tiles along the T dimension; storing the partitioned activation matrix in a global memory; and determining, by a compute unit of the processing system, a partial gram matrix by: a. loading a particular tile of the partitioned activation matrix to an on-chip memory; b. calculating a partial gram matrix from the particular tile using a tensor memory accelerator, bypassing register operations; c. accumulating the partial gram matrix directly to a register of the compute unit; d. loading a next tile of the partitioned activation matrix and repeating a. through c. for each tile activation matrix; and e. writing a final accumulated gram matrix global memory.

Implementations can optionally include one or more of the following features.

In some instances, the on-chip memory implements a swizzled memory mapping scheme.

In some instances, calculating the partial gram matrix from the particular tile comprises calculating

$${A}_{t i l e} * {A}_{t i l e}^{T}$$

where Aₜᵢₗₑ is the activation matrix of the particular tile.

In some instances, each tile of partitioned activation matrix has dimensions T×B_{d}, where B_{d} is a block width selected to accommodate one tile in the on-chip memory.

In some instances, loading the particular tile of the partitioned activation matrix to the on-chip memory comprises using an asynchronous copy engine that is synchronized by a hardware-based transaction barrier.

In some instances, the on-chip memory of the compute unit is associated with a faster read/write speed than the global memory.

In some instances, operations include using the gradient norm to perform differentially private stochastic gradient descent (DP-SGD) during a training process for a machine learning model.

According to a second aspect, one or more computer-readable storage media is provided. The one or more computer-readable storage media stores one or more instructions that, when executable by one or more computers, cause the one or more computers to perform the method according to the first aspect or one or more implementations of the first aspect.

According to a third aspect, a computer-implemented system is provided. The computer-implemented system includes one or more computers and one or more computer memory devices interoperably coupled with the one or more computers. The one or more computer memory devices have computer-readable storage media storing one or more instructions that, when executed by the one or more computers, perform the method according to the first aspect or one or more implementations of the first aspect.

While generally described as computer-implemented software embodied on tangible media that processes and transforms the respective data, some or all of the aspects can be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example AI training environment.

FIG. 2 is a flowchart illustrating an example process for performing differentially private stochastic gradient descent.

FIG. 3 is a flowchart illustrating an example process for calculating a gradient norm using a wide-linear strip mining algorithm.

FIG. 4 is a flowchart illustrating an example process for calculating a gradient norm using an input-length linear algorithm.

FIG. 5 is a flowchart illustrating an example process for calculating a gradient norm using an I/O aware width-linear algorithm.

FIG. 6 is a flowchart illustrating an example process for calculating a gradient norm using an adaptive algorithm selection scheme.

FIG. 7 is a flowchart illustrating an example process for calculating a gradient norm using a thread-block cluster algorithm.

FIG. 8 is a flowchart illustrating an example process for calculating a gradient norm using a tensor memory accelerator.

FIG. 9 illustrates a schematic diagram of an example computing system.

Like reference numbers and designations in the various drawings indicate like elements.

### DETAILED DESCRIPTION

This specification relates to systems and solutions for efficiently calculating gradient norms when training machine learning models in a differentially private (DP), stochastic gradient descent (SGD) (DP-SGD) environment.

During conventional SGD, sample gradients can be aggregated to determine a direction in which to adjust model weights in order to achieve model convergence. However, to perform DP-SGD, each individual sample's contribution to the overall gradient must be limited to prevent privacy leakage. As a result, a magnitude (or norm) of the gradient for each sample must be computed to determine whether each sample's contribution needs to be clipped. These computations can be prohibitively expensive or time consuming, making performing DP-SGD dependent upon specialized equipment or impossible for certain model dimensions or complexities.

The disclosed solution proposes a set of algorithms and strategies for identifying computational bottlenecks such as, memory limitations, input-output (I/O) bandwidth limitations, or processor speed limitations, and computational techniques to overcome these bottlenecks.

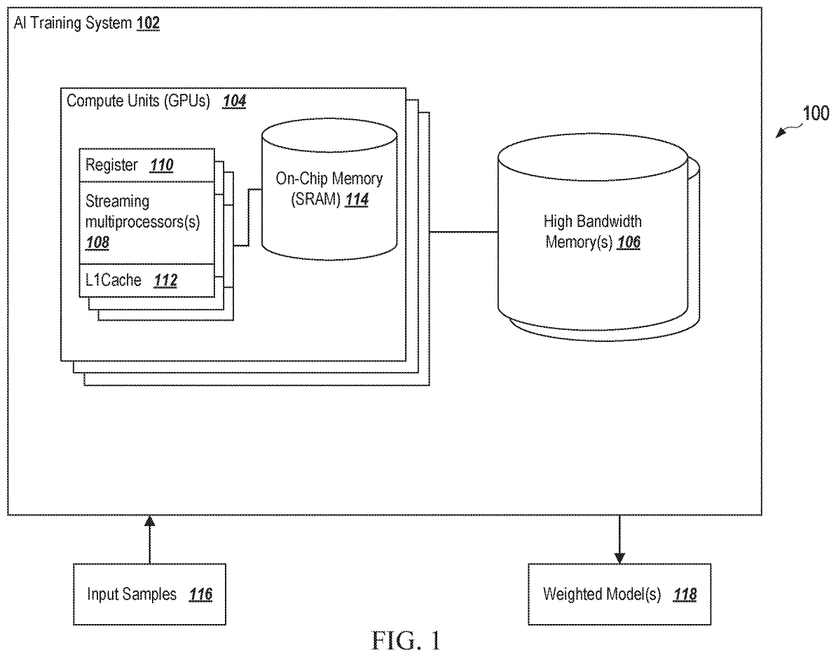

FIG. 1 illustrates a block diagram of an example AI training environment 100. The AI training environment 100 includes an AI training system 102 configured to process input samples 116 to generate and refine (or optimize) weighted models 118. The AI training system 102 comprises a plurality of compute units 104, which may be implemented as graphics processing units (GPUs) arranged in an array or cluster to facilitate parallel processing of neural network operations. For example, the compute units 104 can each be an NVIDIA H100 GPU, Tensor processing units (TPUs), or other systems. Each compute unit 104 is communicatively coupled to high-bandwidth memory (HBM) 106, which provides high-capacity, high-speed storage for large datasets, model parameters, and intermediate computational results. In some implementations, HBM 106 is a custom chip designed as stacked, synchronous dynamic random access memory (SDRAM) such as NVIDIA HBM3, HBM4, or similar architectures.

Within each compute unit 104, one or more streaming multiprocessors 108 are provided to execute the primary computational kernels required for training. The streaming multiprocessors 108 utilize a hierarchical memory structure to optimize data throughput and minimize latency. This structure includes registers 110 for immediate operand storage during execution and a level 1 cache (L1 cache) 112 for local, low-latency data access. Furthermore, each compute unit 104 incorporates an on-chip memory 114, such as static random-access memory (SRAM), which acts as a high-speed buffer between internal caches of the streaming multiprocessors 108 and the external HBM 106. In operation, the AI training system 102 receives input samples 116, which are processed through the compute units 104 using the illustrated memory hierarchy to iteratively update model weights, ultimately outputting the refined weighted models 118.

In some implementations, data flow within the AI training environment 100 begins with acquisition of input samples 116, which are transferred into the AI training system 102 to initiate a training iteration. These input samples 116 can initially be stored within the HBM 106, which functions as a high-capacity repository for a training dataset and a current state of the weighted models 118.

To begin computation, specific subsets of data and model parameters are fetched from the HBM 106 and loaded into the on-chip memory 114 of the compute units 104. The on-chip memory 114 serves as a low-latency buffer that facilitates the rapid exchange of data between the external memory and the internal processing cores. Within each compute unit 104, data is further migrated from the on-chip memory 114 into the L1 cache 112 for immediate proximity to the streaming multiprocessors 108. During the execution of computational kernels, the streaming multiprocessors 108 move operands into the registers 110 where high-speed mathematical operations, such as matrix multiplications, are performed. Each of these operations consumes some communication bandwidth (I/O bandwidth) and available memory. For large models, with either a large input sequence length, or a large number of parameters (model width) the AI system 100 can encounter memory or I/O bottlenecks rendering training of certain models impossible without improved techniques.

As the streaming multiprocessors 108 complete a forward pass, the resulting activation data is temporarily stored in the L1 cache 112 or the on-chip memory 114 to be utilized during a subsequent backward pass. During the backward pass, the compute units 104 calculate gradients based on a difference between the predicted output and the target values provided by the input samples 116. These gradients are used to determine necessary adjustments to the model parameters. The updated parameters are then synchronized across the array of compute units 104 and written back to the HBM 106, effectively updating the state of the model. This cycle can be repeated for numerous iterations until the training criteria are met, at which point finalized parameters are output from the AI training system 102 as the weighted models 118.

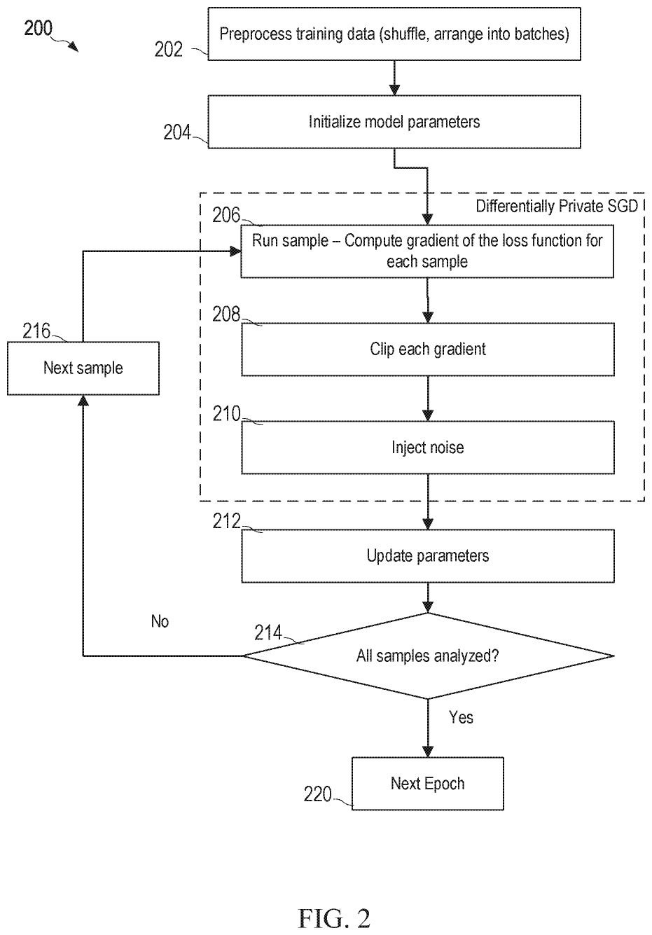

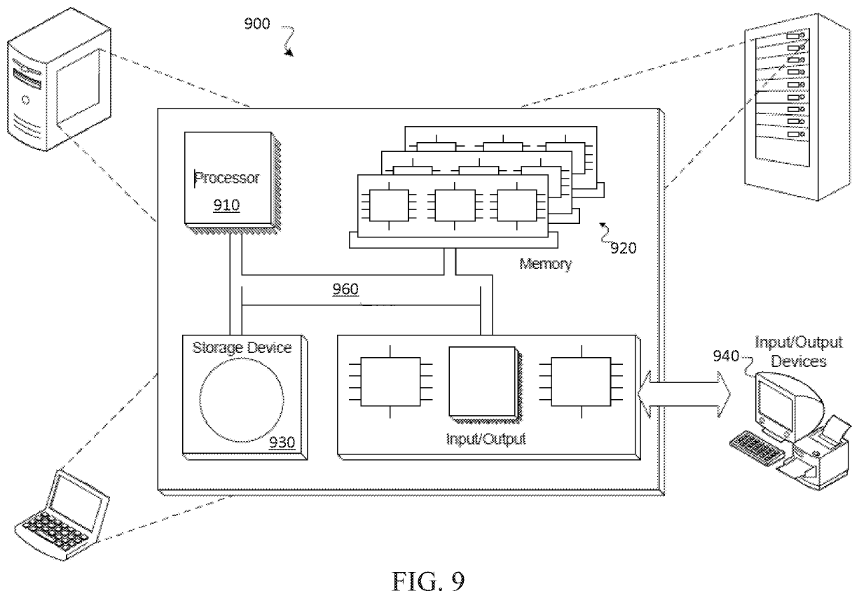

FIG. 2 is a flowchart illustrating an example process 200 for performing DP-SGD. The operations of process 200 can be performed, for example, based on the techniques described with respect to FIGS. 1-8, or in another manner. The operations shown in process 200 may not be exhaustive and that other operations can be performed as well before, after, or between any of the illustrated operations. Further, some of the operations may be performed simultaneously, or in a different order than shown in FIG. 2. In some implementations, some of the operations may be performed by a computer, or multiple computers. The one or more computers the process 200 will be described as being performed by a system of one or more computers, located in one or more locations, and programmed appropriately in accordance with this specification. For example, one or more of an AI training environment 100 of FIG. 1, appropriately programmed, can perform the process 200. As another example, one or more computers in the example system 900 of FIG. 9, when appropriately programmed, can perform the process 200.

At 202, training data is preprocessed, which may include shuffling the data and arranging it into discrete batches to ensure a diverse distribution of samples during the training phase.

At 204, the model parameters are initialized, typically with random weights or pre-trained values, to establish a starting point for the optimization process.

At 206, a sample is run to compute the gradient of the loss function for each individual sample within the training set. This is unique in a DP environment because the gradient must be calculated for each individual sample (in order to perform clipping as discussed below at 208.). During conventional SGD, the loss function can be aggregated to a total loss for an entire training batch. Thus during conventional SGD, the gradient need only be calculated once per batch. In contrast, to ensure no single sample contributes too much information and violates differential privacy, the gradient must be calculated for each sample.

To compute the loss function, for a batch of B samples, and model parameters W, the gradient for each sample gᵢ is computed by computing the loss for each sample Lᵢ with respect to W. This can be computed using the equation:

gᵢ=∇_{W}Lᵢ for i=1, . . . ,B.

At 208, a clipping operation is performed on each gradient to bound the sensitivity of the training process to any single data point, thereby protecting individual privacy. This can be performed by computing the L2 norm of each per-sample gradient and comparing it to a preset clipping threshold C. If the norm exceeds C, the gradient is scaled down proportionally, so its norm exactly equals C. This step ensures that the maximum influence any single sample can have is bounded, no matter how anomalous its content. This can be computed using the equation:

gᵢ_{_{clipped}}=gᵢ*min(1,C/∥gᵢ∥₂),

where ∥gᵢ∥₂ is the L2 norm of the gradient gᵢ. This equation ensures that ∥gᵢ_{_{clipped}}≤C.

At 210, noise is injected into the clipped gradients, which further obscures the contribution of individual samples and ensures that the overall training process adheres to differential privacy standards. The scale of the noise can be determined by the privacy budget (ε,δ). First, sum all clipped gradients in the batch. Then, to satisfy (ε,δ)-differential privacy, noise is added that is sampled from a Gaussian distribution. The noise variance is proportional to the square of the clipping threshold C and the square of the noise multiplier

$$σ \cdot {G}_{private} = ( 1 / B ) * ( {Σ}_{i = 1}^{B} ( {ℊ}_{{i}_{clipped}} ) + N ( 0 , {( σ * C )}^{2} * I ) ) .$$

Here, N(0, (σ*C)²*I) represents Gaussian noise with a mean of 0 and a covariance matrix of (σ*C)²*I, where I is the identity matrix. The noise multiplier σ is a parameter determined based on the specified privacy budget (ε,δ), total training steps, and sampling rate. In some implementations, instead of Gaussian noise, other noise types can be selected. For example, some differential privacy algorithms use Laplacian noise.

At 212, the model parameters are updated based on the noisy, clipped gradients to iteratively improve the accuracy of the model.

At 214, the system determines whether all samples in the current set have been analyzed. If there are remaining samples, the process moves to 216 to fetch the next sample and returns to 206 to continue the gradient computation cycle.

At 220, once all samples have been processed, the next epoch is initiated. The training cycle can repeat until the model reaches convergence or a training budget is exhausted.

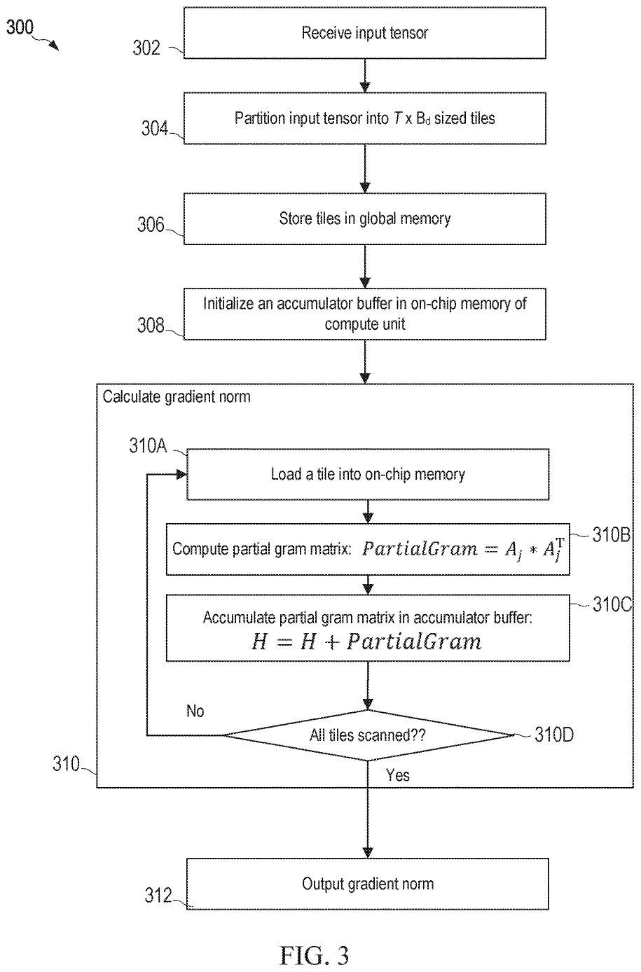

FIG. 3 is a flowchart illustrating an example process 300 for calculating a gradient norm using a wide-linear strip mining algorithm. The operations of process 300 can be performed, for example, based on the techniques described with respect to FIGS. 1 and 2, or in another manner. The operations shown in process 300 may not be exhaustive and that other operations can be performed as well before, after, or between any of the illustrated operations. Further, some of the operations may be performed simultaneously, or in a different order than shown in FIG. 3. In some implementations, some of the operations may be performed by a computer, or multiple computers. The one or more computers the process 300 will be described as being performed by a system of one or more computers, located in one or more locations, and programmed appropriately in accordance with this specification. For example, one or more of an AI training environment 100 of FIG. 1, appropriately programmed, can perform the process 300. As another example, one or more computers in the example system 900 of FIG. 9, when appropriately programmed, can perform the process 300.

Process 300 describes a wide linear strip mining algorithm, which can efficiently calculate a gradient norm for models with large model width d. Conventionally, the entire gradient matrix is stored in memory. However, for large width models (e.g., d>10,000, d>100,000, or other sizes depending on available hardware) the compute unit memory (e.g., video random access memory (VRAM)) can be insufficient. Process 300 describes a width-linear decomposition process that parses the feature dimension in small, manageable “tiles” to maintain a constant memory footprint regardless of how large d becomes.

At 302, an input tensor is received. The input tensor can specify a batch size, sequence length T, input dimension d, as well as accompanying data for the associated sample.

At 304, the input tensor is partitioned into tiles of size T×B_{d} to facilitate efficient on-chip processing. B_{d} can represent the block width size, and can be selected based on the available on-chip memory. For example, the block width can be selected such that the on-chip memory can store an entire block, and additional information necessary for follow-on computation (e.g., the accumulator discussed below at 308).

At 306, these partitioned tiles are stored in global memory for subsequent access by the compute units. The global memory can be, for example, the HBM 106 as described above with respect to FIG. 1.

At 308, the system initializes an accumulator buffer within the on-chip memory of the compute unit to hold intermediate computational values. Specifically the accumulator buffer H can be used to iteratively the partial gradient during computation. In some implementations, the accumulator buffer H is initialized as a T×T matrix with all values at zero.

At 310, the system enters a loop for calculating the gradient norm, starting at 310A where a specific tile is loaded into the on-chip memory. Specifically, an activation matrix A and a gradient matrix g, are loaded for the given tile j. Notably 310 occurs with only a single final write to HBM. That is, all internal computations are stored in the on-chip memory, minimizing I/O bandwidth consumption and enabling rapid processing.

At block 310B, the compute unit calculates a partial Gram matrix using the loaded tile according to the formula:

$$PartialGram = {A}_{j} * {A}_{j}^{T} ,$$

where Aⱼ is the activation matrix for the tile.

At block 310C, this partial Gram matrix is accumulated into the accumulator buffer via the operation H=H+PartialGram.

At 310D, the system determines if all tiles have been scanned. If there are remaining tiles, the process returns to 310A to load the next tile; otherwise, it proceeds to the final step.

Finally, at block 312, the system outputs the resulting gradient norm (the completed H matrix) derived from the accumulated data.

An advantage of this process 300 is that the on-chip memory need only store the accumulator H (size T×T) and a single tile (size T×B_{d}) in on-chip memory. Thus the gradient norm calculation, which was previously limited by a maximum size of the input parameters d, is now limited by the time it takes to load each tile. That is, the problem has been transferred from a memory bound problem to an I/O bound problem.

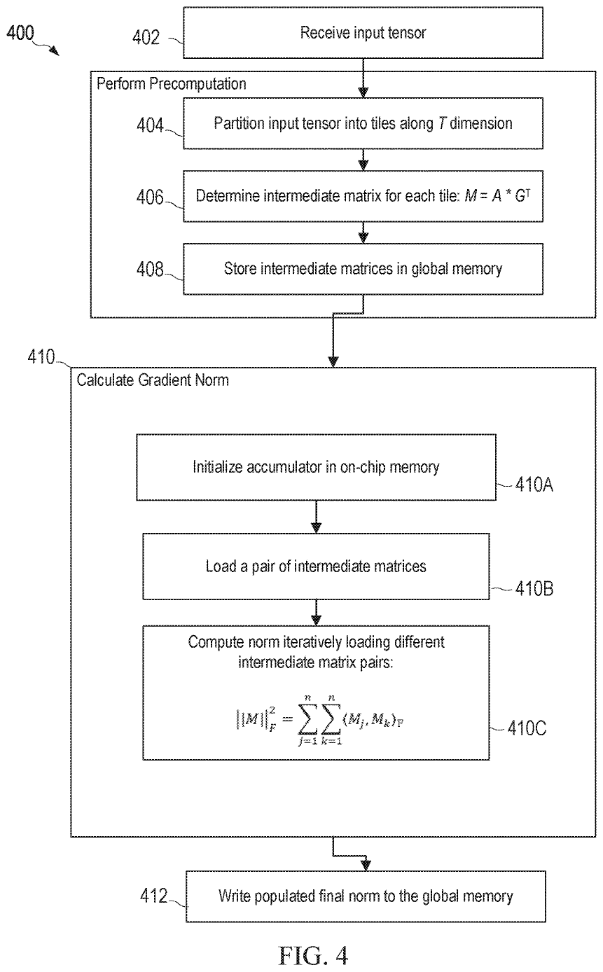

FIG. 4 is a flowchart illustrating an example process 400 for calculating a gradient norm using an input-length linear algorithm. The operations of process 400 can be performed, for example, based on the techniques described with respect to FIGS. 1 and 2, or in another manner. The operations shown in process 400 may not be exhaustive and that other operations can be performed as well before, after, or between any of the illustrated operations. Further, some of the operations may be performed simultaneously, or in a different order than shown in FIG. 4. In some implementations, some of the operations may be performed by a computer, or multiple computers. The one or more computers the process 400 will be described as being performed by a system of one or more computers, located in one or more locations, and programmed appropriately in accordance with this specification. For example, one or more of an AI training environment 100 of FIG. 1, appropriately programmed, can perform the process 400. As another example, one or more computers in the example system 900 of FIG. 9, when appropriately programmed, can perform the process 400.

Process 400 describes an input-length-linear algorithm, which can efficiently calculate a gradient norm for models with long or large input sequence lengths T. Conventional processes require storing an entirety of model parameters in memory. As input sequence length gets larger, memory requirements increase by T, which rapidly causes VRAM memory requirements that exceed current technology. The input-length-linear algorithm uses the cyclic property of a matrix trace (or trace swap) to reframe a computation from a quadratic sequence-length operation into a linear operation. For example, instead of computing:

tr((A*A^{T})*(G*G^{T})),

using a trace swap, the gradient can be computed as:

$${‖ ℊ ‖}_{F}^{2} = tr ( ( A * {A}^{T} ) * ( G * {G}^{T} ) ) = t r ( {A}^{T} * G * {G}^{T} * A ) = t r ( ( {A}^{T} * G ) * {( {A}^{T} * G )}^{T} ) ,$$

selecting an intermediate matrix as M=A^{T}*G, and A^{T} is d×T and G is T×p, where the resulting matrix Mis dimensions d×p. Notably, these intermediate matrices are size independent of T.

This computation can be efficiently accomplished by performing a one-time pre-computation then looping a Frobenius inner product. This input-length-linear algorithm is particularly useful for models where T is larger than d.

Process 400 begins at 402 with the receipt of an input tensor, which contains the raw data and/or activations required for the gradient calculation.

The system then initiates a precomputation phase, which begins at 404 by partitioning the received input tensor into tiles along the T dimension, allowing the system to process data in chunks that fit within the on-chip of the compute unit.

At 406, the system determines an intermediate matrix M for each partitioned tile by multiplying the activation matrix by the transposed gradient matrix from the input tensor: M=A*G^{T}.

At 408, these calculated intermediate matrices are stored in global memory, such as HBM, where they remain accessible to the compute units for the more computationally intensive norm calculation phase that follows.

The process then transitions into the gradient norm calculation phase 410, which starts at 410A by initializing an accumulator within the on-chip memory of the compute unit to ensure that the running sum of the norm remains local to the compute unit. In some implementations, the accumulator is a “total norm squared” value that is initialized to zero.

At 410B, the system begins the iterative computation by loading a pair of the previously stored intermediate matrices from the global memory into the high-speed on-chip memory.

At block 410C, the compute unit calculates the squared Frobenius norm iteratively by loading different combinations of intermediate matrix pairs and summing their Frobenius inner products according to the formula:

$${‖ M ‖}_{F}^{2} = {Σ}_{j = 1}^{n} {Σ}_{k = 1}^{n} {〈 {M}_{j} , {M}_{k} 〉}_{F} ,$$

where the double summation accounts for all pairwise interactions between the tiles. This is true where:

M=ΣⱼMⱼ.

Finally, at block 412, the system writes the populated and finalized gradient norm value back to the global memory, where it can be used for downstream tasks such as gradient clipping in a differentially private training loop.

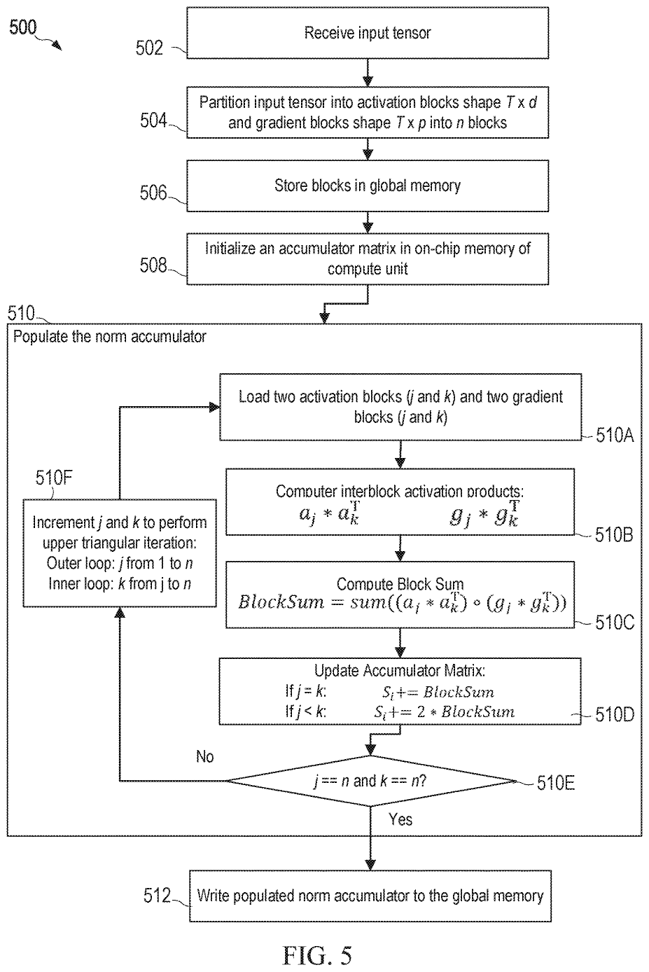

FIG. 5 is a flowchart illustrating an example process 500 for calculating a gradient norm using an I/O aware width-linear algorithm. The operations of process 500 can be performed, for example, based on the techniques described with respect to FIGS. 1 and 2, or in another manner. The operations shown in process 500 may not be exhaustive and that other operations can be performed as well before, after, or between any of the illustrated operations. Further, some of the operations may be performed simultaneously, or in a different order than shown in FIG. 5. In some implementations, some of the operations may be performed by a computer, or multiple computers. The one or more computers the process 500 will be described as being performed by a system of one or more computers, located in one or more locations, and programmed appropriately in accordance with this specification. For example, one or more of an AI training environment 100 of FIG. 1, appropriately programmed, can perform the process 500. As another example, one or more computers in the example system 900 of FIG. 9, when appropriately programmed, can perform the process 500.

Process 500 describes an I/O aware width-linear algorithm. This algorithm additionally addresses the space complexity failure that occurs with large input sequence lengths T. Instead of performing a precompute phase, process 500 partitions the activation and output gradient from the input tensor into blocks along the T dimension, and performs a fused kernel computation in the on-chip memory that iterates in an upper triangle of the matrices to efficiently accumulate the norm value without making any intermediate T×T matrix writes to the global memory.

The process begins at block 502 with the receipt of an input tensor containing the data necessary for the gradient calculation.

At 504, the system partitions the input tensor into activation blocks of shape T×d and gradient blocks of shape T×p, dividing the data into n discrete blocks to allow for granular, parallelized processing without exceeding the on-chip memory capacity.

At 506, these activation and gradient blocks are stored in global memory, serving as a centralized repository for the compute units to access throughout the iteration process.

At 508, the system initializes an accumulator matrix within the on-chip memory of a compute unit, providing a high-speed local buffer to store and update the running norm total. The system then enters a comprehensive routine 510 to populate the norm accumulator, which starts at block 510A by loading a pair of activation blocks (indices j and k) and a corresponding pair of gradient blocks from the global memory.

At block 510B, the compute unit calculates the interblock activation and gradient products and gradient products, specifically performing the matrix multiplications

$${a}_{j} * {a}_{k}^{T} and {ℊ}_{j} * {ℊ}_{k}^{T} .$$

At block 510C, the system computes a block sum by taking the sum of the Hadamard (element-wise) product of these two result matrices, represented by the formula:

$$Block Sum = sum ( ( {a}_{j} * {a}_{k}^{T} ) ∘ ( {ℊ}_{j} * {ℊ}_{k}^{T} ) ) .$$

At block 510D, the accumulator matrix Si is updated based on the relationship between the indices: if j equals k, the BlockSum is added directly to the accumulator. This represents a value that is along the diagonal of the input tensor and so it is counted once in the accumulator. If j is less than k, twice the BlockSum is added to account for the symmetric property of the matrix without needing a separate calculation for the lower triangular counterpart.

At 510E, the system checks if the indices j and k have both reached the final block n. If the iteration is not complete, the process proceeds to block 510F, where j and k are incremented according to an upper triangular iteration pattern (an outer loop for j from 1 to n and an inner loop for k from j to n) before returning to block 510A.

Finally, once all blocks have been processed, the system proceeds to block 512 to write the fully populated norm accumulator back to the global memory.

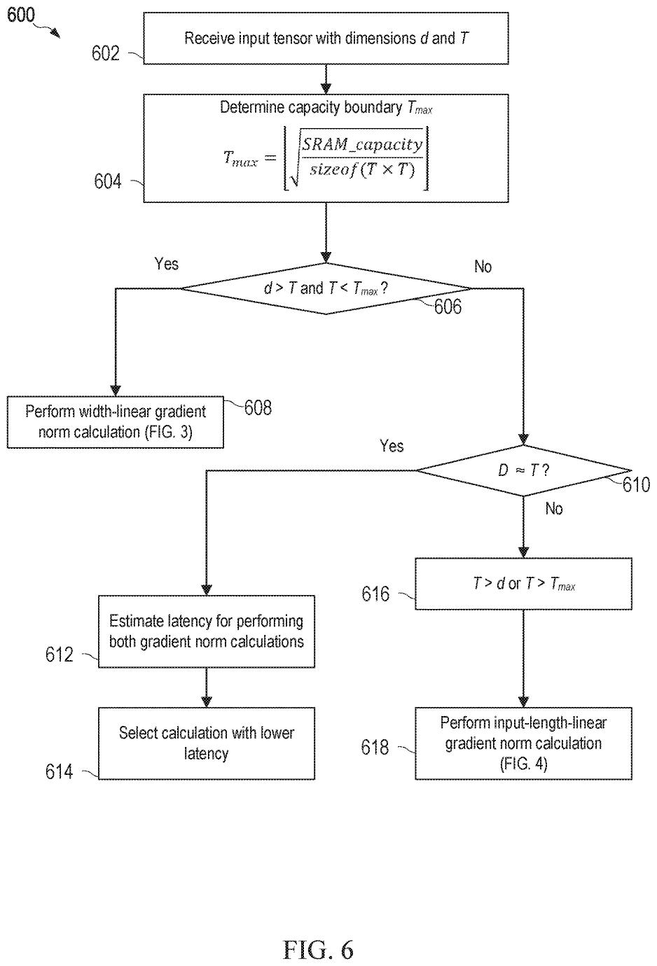

FIG. 6 is a flowchart illustrating an example process 600 for calculating a gradient norm using an adaptive algorithm selection scheme. The operations of process 600 can be performed, for example, based on the techniques described with respect to FIGS. 1-5, or in another manner. The operations shown in process 600 may not be exhaustive and that other operations can be performed as well before, after, or between any of the illustrated operations. Further, some of the operations may be performed simultaneously, or in a different order than shown in FIG. 6. In some implementations, some of the operations may be performed by a computer, or multiple computers. The one or more computers the process 600 will be described as being performed by a system of one or more computers, located in one or more locations, and programmed appropriately in accordance with this specification. For example, one or more of an AI training environment 100 of FIG. 1, appropriately programmed, can perform the process 600. As another example, one or more computers, in the example system 900 of FIG. 9, when appropriately programmed, can perform the process 600.

The described adaptive algorithm selection scheme can be used to enable an AI training system to select the appropriate norm calculation algorithm based on the available hardware, I/O bandwidth, and model parameters.

The process 600 begins at 602 with the receipt of an input tensor characterized by dimensions d (representing model width or hidden dimension size) and T (representing the input length or sequence length).

At 604, the system determines a capacity boundary, Tₘₐₓ, which defines the maximum tile size that can be accommodated within the on-chip memory (e.g., SRAM). This is calculated by taking the square root of the quotient of the SRAM capacity divided by the size of a T×T matrix:

$${T}_{max} = \sqrt{\frac{SRAM\_capacity}{sizeof ( T \times T )}} .$$

The system then evaluates a primary condition at 606 to determine if the model width is significantly larger than the sequence length (d>T) and if that sequence length fits within the calculated memory boundary (T<Tₘₐₓ). If both conditions are met, the process continues at 608 and executes the width-linear gradient norm calculation described above in FIG. 3, as this algorithm is more performative for scenarios where T is small relative to d.

If the conditions at 606 are not met, the process moves to 610 to check if the dimensions d and T are approximately equal (d≈T). In the event that the dimensions are comparable, the system proceeds to 612 to perform a latency estimation for both the FIG. 3 and FIG. 4 calculation methods. In some implementations, d and T can be considered approximately equal when they are within 10% of each other. Other thresholds and amounts are possible. In some instances, this threshold can be user selectable and adapted between training iterations.

At 612, the predicted latency can be performed using a JIT analytical cost model. To estimate the latency for the width-linear strip mining algorithm (FIG. 3) the system can consider the size of the input tensor, the available floating point operations per second (FLOPS) for each compute unit and the average latency or time required to perform an all-reduce operation based on the current compute units, Treduce( ). The estimated latency for the width-linear strip mining algorithm can be calculated as:

Latency_{FIG. 3}≈(d*T²)/Peak_FLOPS+Treduce(K).

Similarly, the latency for the input-length-linear algorithm can be calculated as:

Latency_{B}≈(T*d*p)/Peak_FLOPS.

Following this estimation, at 614, the system selects and executes the specific calculation method that demonstrates the lower predicted latency for that specific workload.

Returning to decision 610, if d and T are not approximately equal, the system identifies at block 616 that the sequence length is larger than the model width (T>d) or exceeds the hardware capacity boundary (T>Tₘₐₓ). Under these conditions, the process proceeds to block 618 and performs the input-length-linear gradient norm calculation described in FIG. 4, which is better suited for handling long sequences or memory-constrained environments. In some implementations, the algorithm described above with respect to FIG. 5 can be used instead of FIG. 4. Specifically in scenarios where precomputation is undesirable.

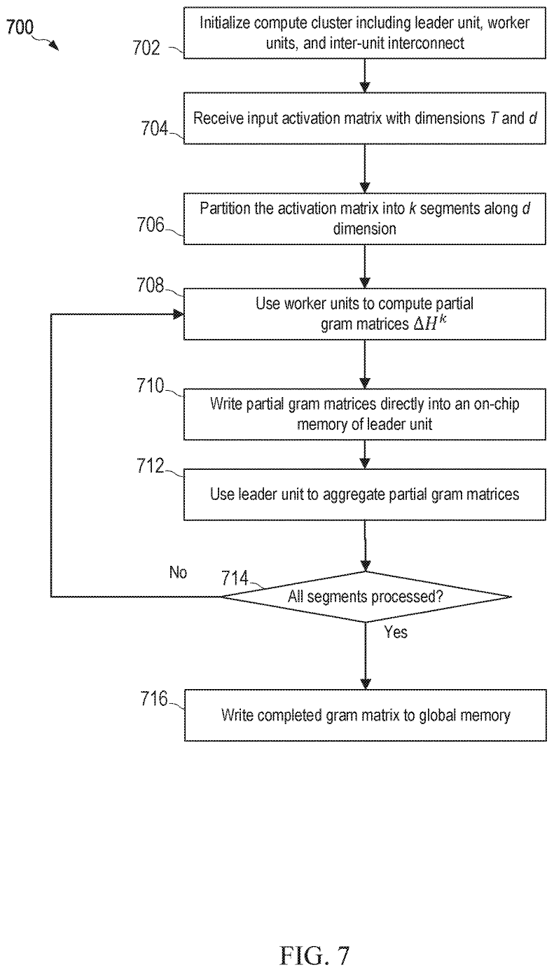

FIG. 7 is a flowchart illustrating an example process 700 for calculating a gradient norm using a thread-block cluster algorithm. The operations of process 700 can be performed, for example, based on the techniques described with respect to FIGS. 1-6, or in another manner. The operations shown in process 700 may not be exhaustive and that other operations can be performed as well before, after, or between any of the illustrated operations. Further, some of the operations may be performed simultaneously, or in a different order than shown in FIG. 7. In some implementations, some of the operations may be performed by a computer, or multiple computers. The one or more computers the process 700 will be described as being performed by a system of one or more computers, located in one or more locations, and programmed appropriately in accordance with this specification. For example, one or more of an AI training environment 100 of FIG. 1, appropriately programmed, can perform the process 700. As another example, one or more computers in the example system 900 of FIG. 9, when appropriately programmed, can perform the process 700.

Process 700 contemplates performing a norm calculation in a hardware environment where a thread-block cluster compute is available. This is beneficial in an environment where a group of coupled compute units (cluster) are able to access each other's on-chip memory, and in the disclosed solution, perform aggregation entirely on chip without performing writes to HBM.

FIG. 7 uses a leader-worker architecture within the compute cluster, designed to scale the operations described in previous figures across multiple hardware units. The process begins at 702 with the initialization of a compute cluster, which includes the designation of a leader unit, a plurality of worker units, and the setup of an inter-unit interconnect to facilitate high-speed data transfer between the units.

At 704, the system receives an input activation matrix characterized by dimensions T and d (representing input length and model width, respectively), which serves as the primary data source for the distributed Gram matrix calculation.

At 706, the system partitions the received activation matrix into k discrete segments along the d dimension, allowing different portions of the model width to be processed in parallel across the available worker units.

At 708, the worker units are each assigned to compute partial a Gram matrice, denoted as ΔH^{k}, for their respective segments of the activation matrix. In some implementations, the worker units can use specialized direct memory access instructions (e.g., st.shared.cluster).

At 710, rather than writing back to the relatively slow global memory, the worker units write the resulting partial Gram matrices directly into the on-chip memory of the designated leader unit via the inter-unit interconnect, significantly reducing data transfer overhead.

At 712, the leader unit performs an aggregation step, summing or combining the incoming partial Gram matrices received from the various worker units to form the global Gram matrix. Performing the computation:

Hₜₒₜₐₗ=sum(ΔHₖ).

At decision 714, the system determines whether all k segments have been processed and aggregated; if segments remain, the process loops back to 708 to continue processing the next set of tiles.

Finally, at 716, once the aggregation for all segments is complete, the leader unit writes the finalized, complete Gram matrix to the global memory for use in the broader training or optimization loop.

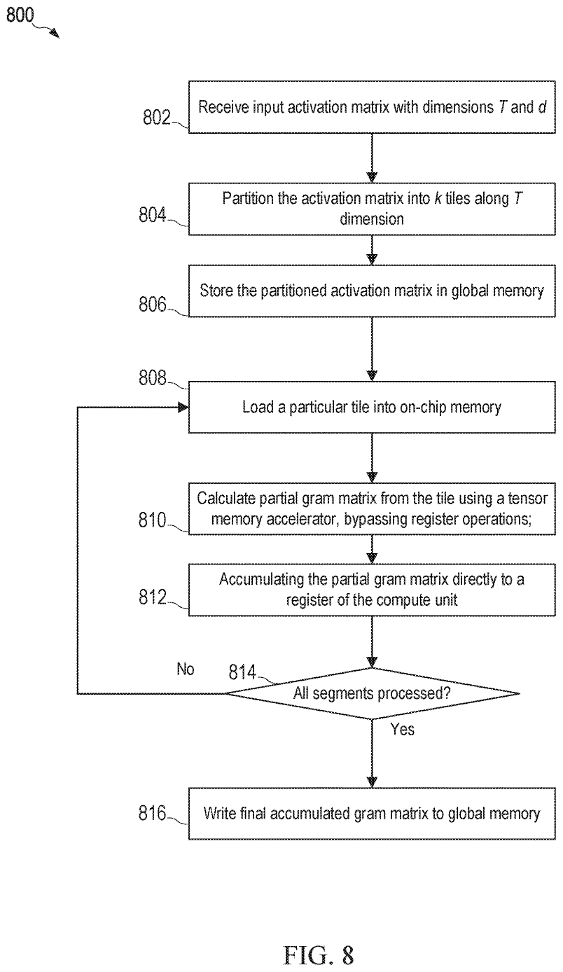

FIG. 8 is a flowchart illustrating an example process 800 for calculating a gradient norm using a tensor memory accelerator. The operations of process 800 can be performed, for example, based on the techniques described with respect to FIGS. 1-7, or in another manner. The operations shown in process 800 may not be exhaustive and that other operations can be performed as well before, after, or between any of the illustrated operations. Further, some of the operations may be performed simultaneously, or in a different order than shown in FIG. 8. In some implementations, some of the operations may be performed by a computer, or multiple computers. The one or more computers the process 800 will be described as being performed by a system of one or more computers, located in one or more locations, and programmed appropriately in accordance with this specification. For example, one or more of an AI training environment 100 of FIG. 1, appropriately programmed, can perform the process 800. As another example, one or more computer in the example system 900 of FIG. 9, when appropriately programmed, can perform the process 800.

This process 800 relates to a method for optimizing the data path and register utilization of tensor core operations (such as NVIDIA's warp group matrix multiply accumulate (WGMMA)) to accelerate the computation of gradient norms in DP-SGD. Modem high-performance GPUs (e.g., NVIDIA Hopper H100) use specialized compute units, or Tensor Cores for matrix-matrix multiplication. However, standard implementation patterns face a significant efficiency ceiling.

Conventional matrix multiplication kernels (e.g., Amperegeneration half-precision matrix multiply and accumulate (HMMA)) require input operands to be loaded from shared memory (SRAM) into the register file (RF) before they can be processed by the math units. In DP-SGD, the system must maintain a T×T accumulator matrix H to compute per-sample norms. As sequence length T increases, the number of registers required for this accumulator grows quadratically. If a significant portion of the register file is occupied by “temporary” input data loaded from SRAM, there are fewer registers available for the accumulator. This forces the use of smaller “tile sizes”, which can lead to increased instruction overhead, lower hardware utilization, and frequent stalls.

Process 800 improves the execution of the outer product used to calculate the Gram matrix H. This is achievable by calculating H=sumₜᵢₗₑ(Aₜᵢₗₑ*Aₜᵢₗₑ^{T}). In this equation Aₜᵢₗₑ is the activation tile of shape T×B_{d}, and H is the T×T accumulator matrix residing in the fastest possible storage tier, registers.

The process begins at 802 with the receipt of an input activation matrix characterized by dimensions T (input sequence length) and d (model width), which serves as the data source for the subsequent norm or Gram matrix calculations.

At 804, the system partitions the activation matrix into k discrete tiles along the T dimension, allowing the system to process specific sequence segments independently and efficiently manage local memory capacity.

At 806, the partitioned activation matrix is stored in global memory, ensuring the data is staged for the compute unit's memory hierarchy.

The system then initiates a calculation loop, starting at 808 where a particular tile is loaded from global memory into the high-speed on-chip memory of the compute unit. When a particular tile is loaded into the on-chip memory at 808, the data is not necessarily stored in a linear, row-major, or column-major format; instead, the system can apply a bit-swizzling transformation to the memory addresses. This transformation rearranges the mapping of the activation or gradient matrix elements to the underlying physical memory banks of the SRAM. By decorrelating the logical 2D indices of the tile—such as the sequence index T and the feature index d—from the physical bank indices, the swizzled layout pattern effectively eliminates or significantly reduces bank conflicts that occur when multiple threads or hardware lanes attempt to access different data elements within the same memory bank simultaneously.

At 810, the compute unit calculates a partial Gram matrix from the loaded tile by utilizing a specialized tensor memory accelerator; this hardware-specific optimization allows the system to perform high-throughput matrix operations while specifically bypassing standard register operations to reduce data movement latency.

At 812, the resulting partial Gram matrix is accumulated directly into a register of a leader compute unit, maintaining a running total of the global Gram matrix state within the processor's immediate vicinity.

At decision 814, the system evaluates whether all segments and tiles have been processed. If there are remaining segments, the process loops back to 808 to load and process the next tile; otherwise, it proceeds to completion.

Finally, at 816, once all tiles have been aggregated, the finalized accumulated Gram matrix is written back to the global memory for use in downstream training tasks, such as calculating the final gradient norm for clipping.

FIG. 9 illustrates a schematic diagram of an example computing system 900. The system 900 can be used for the operations described in association with the implementations described herein. For example, the system 900 may be included in computing devices of the one or more online components and/or the one or more offline components. The system 900 includes a processor 910, a memory 920, a storage device 930, and an input/output device 940, which are interconnected using a system bus 950. The processor 910 is capable of processing instructions for execution within the system 900. In some implementations, the processor 910 is a single-threaded processor. The processor 910 is a multi-threaded processor. The processor 910 is capable of processing instructions stored in the memory 920 or on the storage device 930 to display graphical information for a user interface on the input/output device 940.

The memory 920 stores information within the system 900. In some implementations, the memory 920 is a computer-readable medium. The memory 920 can be a volatile memory unit or a non-volatile memory unit. The storage device 930 is capable of providing mass storage for the system 900. The storage device 930 is a computer-readable medium. The storage device 930 may be a floppy disk device, a hard disk device, an optical disk device, or a tape device. The input/output device 940 provides input/output operations for the system 900. The input/output device 940 includes a keyboard and/or pointing device. The input/output device 940 includes a display unit for displaying graphical user interfaces.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, arandom or serial access memory device, or a combination of one or more of them. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship with each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%,90%, 95%, 96%, 97%, 98%, 99%, 99.5% 99.9%, 99.99%, or at least about 99.999% or more.

Values expressed in a range format should be interpreted in a flexible manner to include not only the numerical values explicitly recited as the limits of the range, but also the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required to be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations but should be defined only in accordance with the following claims and their equivalents. Accordingly, other implementations also are within the scope of the claims.

What is claimed is:

1. A computer-implemented method comprising:
receiving, at a processing system for training machine learning models, an input activation matrix of dimensions T and d, where T is the input sequence length and d is a model width
partitioning the input activation matrix into a plurality of tiles along the T dimension;
storing the partitioned activation matrix in a global memory; and
determining, by a compute unit of the processing system, a partial gram matrix by:
a. loading a particular tile of the partitioned activation matrix to an on-chip memory;
b. calculating a partial gram matrix from the particular tile using a tensor memory accelerator, bypassing register operations;
c. accumulating the partial gram matrix directly to a register of the compute unit;
d. loading a next tile of the partitioned activation matrix and repeating a. through c. for each tile activation matrix; and
e. writing a final accumulated gram matrix global memory.

2. The computer-implemented method of claim 1, wherein the on-chip memory implements a swizzled memory mapping scheme.

3. The computer-implemented method of claim 1, wherein calculating the partial gram matrix from the particular tile comprises calculating
$${A}_{t i l e} * {A}_{t i l e}^{T}$$
where Aₜᵢₗₑ is the activation matrix of the particular tile.

4. The computer-implemented method of claim 1, wherein each tile of partitioned activation matrix has dimensions T×B_{d}, where B_{d} is a block width selected to accommodate one tile in the on-chip memory.

5. The computer-implemented method of claim 1, wherein loading the particular tile of the partitioned activation matrix to the on-chip memory comprises using an asynchronous copy engine that is synchronized by a hardware-based transaction barrier.

6. The computer-implemented method of claim 1, wherein the on-chip memory of the compute unit is associated with a faster read/write speed than the global memory.

7. The computer-implemented method of claim 1, comprising using the gradient norm to perform differentially private stochastic gradient descent (DP-SGD) during a training process for a machine learning model.

8. One or more non-transitory computer-readable storage medium storing one or more instructions that, when executable by one or more computers, cause the one or more computers to perform operations comprising:
receiving, at a processing system for training machine learning models, an input activation matrix of dimensions T and d, where T is the input sequence length and d is a model width partitioning the input activation matrix into a plurality of tiles along the T dimension;
storing the partitioned activation matrix in a global memory; and
determining, by a compute unit of the processing system, a partial gram matrix by:
a. loading a particular tile of the partitioned activation matrix to an on-chip memory;
b. calculating a partial gram matrix from the particular tile using a tensor memory accelerator, bypassing register operations;
c. accumulating the partial gram matrix directly to a register of the compute unit;
d. loading a next tile of the partitioned activation matrix and repeating a. through c. for each tile activation matrix; and
e. writing a final accumulated gram matrix global memory.

9. The medium of claim 8, wherein the on-chip memory implements a swizzled memory mapping scheme.

10. The medium of claim 8, wherein calculating the partial gram matrix from the particular tile comprises calculating
$${A}_{t i l e} * {A}_{t i l e}^{T}$$
where Aₜᵢₗₑ is the activation matrix of the particular tile.

11. The medium of claim 8, wherein each tile of partitioned activation matrix has dimensions T×B_{d}, where B_{d} is a block width selected to accommodate one tile in the on-chip memory.

12. The medium of claim 8, wherein loading the particular tile of the partitioned activation matrix to the on-chip memory comprises using an asynchronous copy engine that is synchronized by a hardware-based transaction barrier.

13. The medium of claim 8, wherein the on-chip memory of the compute unit is associated with a faster read/write speed than the global memory.

14. The medium of claim 8, the operations comprising using the gradient norm to perform differentially private stochastic gradient descent (DP-SGD) during a training process for a machine learning model.

15. A computer-implemented system, comprising:
one or more computers; and
one or more computer memory devices interoperably coupled with the one or more computers and having computer-readable storage media storing one or more instructions that, when executed by the one or more computers, perform one or more operations comprising:
receiving, at a processing system for training machine learning models, an input activation matrix of dimensions T and d, where T is the input sequence length and d is a model width
partitioning the input activation matrix into a plurality of tiles along the T dimension;
storing the partitioned activation matrix in a global memory; and
determining, by a compute unit of the processing system, a partial gram matrix by:
a. loading a particular tile of the partitioned activation matrix to an on-chip memory;
b. calculating a partial gram matrix from the particular tile using a tensor memory accelerator, bypassing register operations;
c. accumulating the partial gram matrix directly to a register of the compute unit;
d. loading a next tile of the partitioned activation matrix and repeating a. through c. for each tile activation matrix; and
e. writing a final accumulated gram matrix global memory.

16. The system of claim 15, wherein the on-chip memory implements a swizzled memory mapping scheme.

17. The system of claim 15, wherein calculating the partial gram matrix from the particular tile comprises calculating
$${A}_{t i l e} * {A}_{t i l e}^{T}$$
where Aₜᵢₗₑ is the activation matrix of the particular tile.

18. The system of claim 15, wherein each tile of partitioned activation matrix has dimensions T×B_{d}, where B_{d} is a block width selected to accommodate one tile in the on-chip memory.

19. The system of claim 15, wherein loading the particular tile of the partitioned activation matrix to the on-chip memory comprises using an asynchronous copy engine that is synchronized by a hardware-based transaction barrier.

20. The system of claim 15, wherein the on-chip memory of the compute unit is associated with a faster read/write speed than the global memory.
